(19) United States
(12) Patent Application Publication
(10) Pub. No.: US 2014/0301707 A1
(43) Pub. Date: Oct. 9, 2014

(54) OPTICAL WAVEGUIDE, MODE SCRAMBLER AND MODE CONDITIONER FOR CONTROLLING MODE POWER DISTRIBUTION

(71) Applicant: INSTITUT NATIONAL D'OPTIQUE, Sainte-Foy (CA)

(72) Inventors: Marco Michele SISTO, Quebec (CA); Claude PARE, St-Augsutin-de-Desmaures (CA); Andre CROTEAU, St-Agapit (CA)

(73) Assignee: INSTITUT NATIONAL D'OPTIQUE, Sainte-Foy (CA)

(21) Appl. No.: 13/859,075

(22) Filed: Apr. 9, 2013

(51) Int. Cl. G02B 6/028

(52) U.S. Cl. CPC G02B 6/0288
USPC 385/124; 385/123

(57) ABSTRACT

The present disclosure relates to a multimode optical waveguide comprising a cladding and a core. The core of the multimode optical waveguide has a polygonal cross-section. The core forms a coil spun around the longitudinal axis of the cladding. The multimode optical waveguide may be used to realize a mode scrambler and a mode conditioner.

### TECHNICAL FIELD

The present disclosure relates to the field of optical waveguide systems. More specifically, the present disclosure relates to an optical waveguide, a mode scrambler and a mode conditioner for controlling the mode power distribution of the light guided by an optical waveguide system.

### BACKGROUND

Several characteristics that describe the behavior of multimode optical fibers (MMFs) depend on how the light is injected into the fiber. One such characteristic is named mode power distribution (MPD). Another important characteristic is the loss of transmission bandwidth over distance, known as a bandwidth-distance product. Monitoring these characteristics with precision and reproducibility requires a standardized method for controlling the modal content of a fiber.

Several industrial standards have been proposed over the years to control the MPD of a MMF. An emerging standard is the IEC 61280-4-1 published by the International Electrotechnical Commission (IEC). This standard is based on an analysis of the measured energy (or power) encircled within a given radius. A resulting curve, called an encircled flux (EF) curve, represents this energy as a function of the radial distance from the core axis of the optical fiber. The IEC 61280-4-1 standard defines compliance limits for an EF curve of a waveguide under test. The Telecommunications Industry Association (TIA) has recently incorporated the same method in its own standard TIA-526-14-B. In general, these standards represent an improvement over earlier standards defining distribution of modes in a fiber.

Multimode telecom links require a minimum level of control of the MPD because the impulse response and the bandwidth-distance product of the fiber used in these links depend on it. Typically, the latter is measured in so-called ‘underfill’ and ‘overfill’ conditions. When the fiber is underfilled condition, its bandwidth is typically higher than when it is in the overfilled condition. However, in some cases with few dominant modes, the bandwidth of the fiber in underfilled condition may fall by as much as 50% below the bandwidth of the fiber in overfilled condition. In addition, the bandwidth of the underfilled fiber may vary in presence of a fiber curvature or when other modal coupling conditions are present. This variability in the bandwidth of the fiber is detrimental in terms of reproducibility and reliability of measurements.

Various devices have been proposed for improving modal mixture in MMFs and/or to help filtering high-order modes in MMFs. Some of these devices mechanically stress fibers in one or two points, bend and wrap fibers around mandrels in various configurations, (as in U.S. Pat. No. 4,934,787 to Mitsubishi), press fibers on rough surfaces or otherwise obtain microbending. Some others etch the fibers to cause scattering. Yet other devices connect a single mode fiber with a lateral offset with respect to a MMF axis, or provide an angled launch into the MMF (such as in U.S. Pat. No. 6,810,175 to Terabeam), with or without an angled cleave. A diffusing fiber obtained through devitrification or by use of a diffusing bulk material inserted between fibers is sometimes used (such as described in U.S. Pat. No. 6,895,146 to Terabeam). One of the most often used solutions comprises combinations of step-index and graded-index fibers (as described in U.S. Pat. No. 4,229,067 to Corning). Long-period gratings created with microbends, ion implantation, or fiber periodic tapering with CO₂ lasers are also used. A spatial phase mask or a diffraction grating is sometimes used to break the spatial phase distribution of a Gaussian beam from a single-mode fiber in order to excite many modes. Some devices are based on a slanted fiber Bragg grating etched on a H₂-loaded MMF. Most of these devices suffer from one or more significant drawbacks, including large mechanical dimensions, high losses, poor reproducibility, difficulty of use in practical contexts, and the like.

Therefore, there is a need for new devices and methods for controlling the mode power distribution of optical fiber systems while overcoming at least some of the drawbacks of earlier solutions.

### SUMMARY

According to the present disclosure, there is provided a multimode optical waveguide that comprises a cladding and a core having a polygonal cross-section, the core forming a coil spun around an axis of the cladding.

According to the present disclosure, there is provided a mode scrambler comprising an input waveguide connected to a multimode optical waveguide. The multimode optical waveguide comprises a cladding and a core having a polygonal cross-section, the core forming a coil spun around an axis of the cladding. The mode scrambler provides strong coupling among the guided optical modes.

According to the present disclosure, there is also provided a mode conditioner that comprises an input waveguide, a multimode optical waveguide and a mode filter connected to the output of the multimode optical waveguide. The multimode optical waveguide comprises a cladding and a core having a polygonal cross-section, the core forming a coil spun around an axis of the cladding. The multimode optical waveguide is configured to provide strong coupling among the guided optical modes. The mode filter is configured to attenuate or reject the high-order guided modes of the multimode optical waveguide, while the fundamental mode and other low-order guided modes remain unattenuated.

The foregoing and other features will become more apparent upon reading of the following non-restrictive description of illustrative embodiments thereof, given by way of example only with reference to the accompanying drawings.

### BRIEF DESCRIPTION OF THE DRAWINGS

FIG. 1 is a schematic illustration of an optical waveguide according to an embodiment;

FIGS. 2A and 2B are far-field intensity graphs obtained using non-spun core (FIG. 2A) and spun core (FIG. 2B) optical waveguides;

FIG. 3 is a schematic view of a mask configuration in a mode filter;

FIGS. 4A and 4B are graphs showing encircled flux (FIG. 4A) and differential encircled flux (FIG. 4B) for various mask configurations in the mode filter of FIG. 3;

FIG. 5 is a graph of mode transfer functions for various mask configurations in the mode filter of FIG. 3;

FIG. 6 is a schematic illustration of a mode scrambler according to an embodiment;

FIG. 7 is a graph showing compliance of an encircled flux of the mode scrambler of FIG. 6 with the IEC 61280-4-1 standard;

FIG. 8 is a graph of a mode transfer function at an output of the mode scrambler of FIG. 6; and

FIG. 9 is a schematic illustration of a mode conditioner according to an embodiment.

### DETAILED DESCRIPTION

Like numerals represent like features on the various drawings. The present disclosure generally relates to the propagation of light in optical waveguides and, more particularly, to the control of light power distribution between various propagation modes of optical waveguides.

The following terminology is used throughout the present disclosure:
Lateral offset: transverse or lateral deviation from optimum alignment, planned or accidental, of two spliced or butt-coupled fibers.
Underfill: condition of an optical waveguide in which few guided modes transport energy.
Overfill: condition of an optical fiber in which all guided modes transport substantially identical energy levels.
Mode power distribution (MPD): a representation of the relative power in each of the mode groups of a MMF.
Encircled flux: the total optical power, as a function of radius, emanating from a source, as defined in section 2.1 of standard TIA-455-203-A march 2009.
Differential EF (dimensionless): difference between a target encircled flux and measured encircled flux.
Mode transfer function (MTF): a representation of the relative power in each of the modes of a MMF. MTF and MPD are mathematically related and describe the distribution of power among the modes of a MMF. The following equation relates the MTF and the MPD:

$$MTF = \frac{MPD}{m} ,$$

where m is the normalized mode number.
Normalized mode number (m): a normalized index of a specific mode of a MMF. The normalized mode number is defined as:

$$m = \frac{mode number}{total number of modes}$$

Spin or twist pitch: distance over which the core of a fiber is spun by one complete turn around the fiber axis.
Other terms not specifically described herein should be construed as defined in TIA/EIA-440-B Optical fiber terminology, edition 2004.

Various aspects of the present disclosure generally address one or more of the problems of controlling the mode power distribution (MPD) of the light guided by optical waveguide systems. Appropriate control of the MPD allows, for instance, an optimization of the bandwidth-distance product of a multimode waveguide while reducing the sensitivity of this product to vibrations, waveguide temperature and to other effects. The maximum bandwidth-distance product is obtained for a multimode waveguide when only one mode is excited. Such condition is however unstable as any defect of the waveguide, bending, connector or other physical perturbation will cause coupling of light into the other modes. Such coupling is typically time dependent as it is influenced by, for instance, temperature variations and vibrations. The bandwidth-distance product may be severely impaired if only a few modes are excited, thus causing unwanted time-dependent system performance degradations. A more stable condition is obtained when the input light power is distributed over several modes at the entrance of the optical waveguide. As an example, if a multimode optical waveguide is illuminated by a single-mode optical waveguide, a lateral offset at a splicing between the two fibers may be sufficient to achieve a certain level of power distribution. The overfill condition may ultimately appear more advantageous because it is stable. It allows minimizing the bit error rate (BER) penalty on the communication link caused by the so-called modal noise as well. However, the overfill condition is not optimal since it suffers from maximum losses in presence of common sources of mode-dependent losses (MDL), including micro-curvatures of the optical waveguide and misaligned connectors. The encircled flux (EF) condition of the IEC 61280-4-1 standard is an ideal condition, which involves some filtering of the high-order modes. The EF condition retains the stability and low modal noise BER penalty provided by the overfill condition, while also reducing propagation losses.

Control of the mode power distribution in optical waveguide systems has many applications: modal noise increases harmonic distortion and intermodulation effects in radio over optical waveguide applications; control of MPD helps minimizing these effects. In astronomy applications, spectrographs using optical waveguide coupling are used for radial velocity measurements of stars. In such a context, step-index optical waveguides are used in overfill conditions to improve the performance of the spectrograph by ensuring a uniform illumination of the diffraction grating. Step-index optical waveguides are also used in microscopy applications to illuminate samples. Optical components that favor modal mixing improve illumination uniformity. A well-filled MPD minimizes fiber output speckle, which is important in some laser projection applications.

Clearly, there are many applications of multimode optical waveguide that require a modal content approaching either overfill condition or the condition defined by the IEC 61280-4-1 standard. Notably, this is true for multimode telecom links, optical time domain reflectometers for multimode links, link loss test sets, multimode-fiber-based sensors, fiber-based light pipes for projection systems, fiber-based scramblers for spectroscopy applications, and the like.

### Optical Waveguide for Controlling Mode Power Distribution

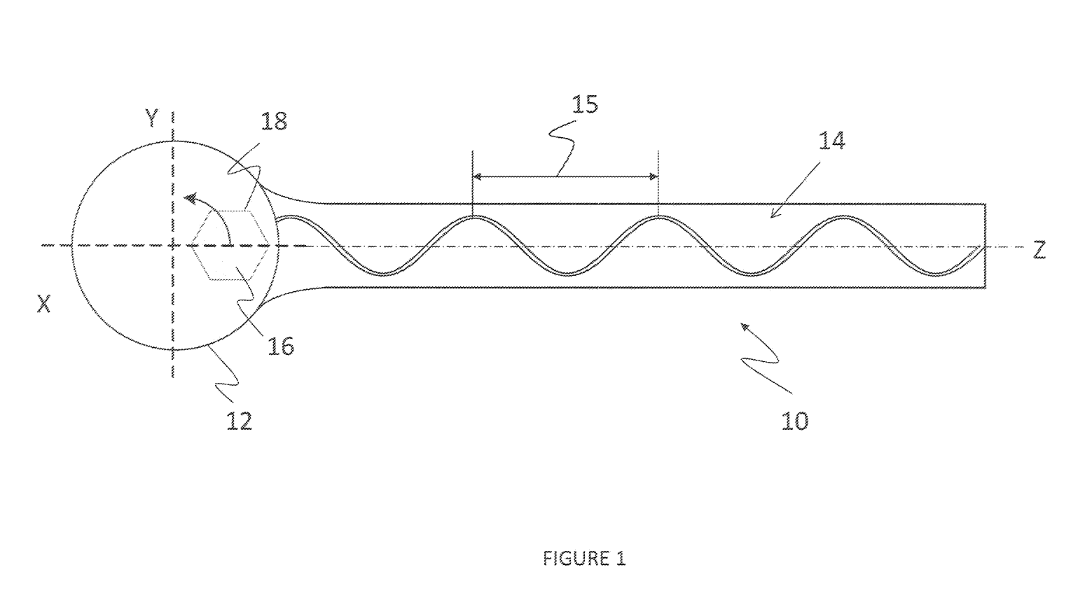

Referring now to the drawings, FIG. 1 is a schematic illustration of a multimode optical waveguide according to an embodiment. A multimode optical waveguide 10 comprises a cladding 12 and an off-centered core 16. The core 16 has a polygonal cross-section 18. The core 16 forms a coil spun around the longitudinal axis 14 of the cladding 12. The core 16 is spun around the axis 14 of the cladding 12 with a pitch 15. The multimode optical waveguide 10 may also be referred to as a spun polygonal core multimode optical waveguide. As shown on FIG. 1, the cross-section 18 of the core 16 is hexagonal. In variants of the multimode optical waveguide 10, the cross-section of the core 16 may be triangular, rectangular, pentagonal, hexagonal, heptagonal or octagonal. FIG. 1 shows that the cross-section 18 of the core 16 forms a regular polygon. In other variants, the cross-section 18 of the core 16 may form an irregular polygon. The pitch 15 corresponds to a distance between two subsequent valleys or two subsequent crests. The pitch 15 has a constant value along the multimode optical waveguide 10. The pitch value may be comprised between a few millimeters and a few centimeters.

The multimode optical waveguide 10 is a step-index waveguide with numerical aperture NA. The relationship between the refractive indices of both core and cladding and the corresponding numerical aperture reads as:

n_{core}²=n_{cladding}²+NA² (1)

The multimode optical waveguide 10 is a multimode fiber (MMF). Its cladding 12 and core 16 may be made up of various polymer materials. In some variants, the cladding 12 may be made of fluorinated SiO₂ while the core 16 may be made of SiO₂. In other variants, the cladding 12 may be made of SiO₂ while the core 16 may be made of doped SiO₂.

The control of the mode power distribution in a MMF may require redistribution and equalization of the propagating optical power over a large number of guided modes. This is referred to as mode scrambling or mode mixing. The particular design of multimode optical waveguide 10 allows for effective mode scrambling over short propagation lengths.

The scrambling of the modes propagating in the multimode optical waveguide 10 is impacted by at least three (3) distinct factors: (i) an amount of lateral offset between an input waveguide and the multimode optical waveguide 10, (ii) the refractive-index differences between the input waveguide and the multimode optical waveguide 10, and (iii) the spinning period, or spin pitch, of the core 16. Factors (i) and (ii) are well-known sources of mode scrambling as light propagating from an input waveguide to the multimode optical waveguide 10 meets the optical interface created at their junction. At the optical interface, the optical power from the input modes is redistributed over the modes of the multimode optical waveguide 10 in a way that depends on the offset and refractive-index differences between the input waveguide and the multimode optical waveguide 10. Hence, a large number of modes of the multimode optical waveguide 10 can be excited, thus favoring mode scrambling upon propagation along the length of the multimode optical waveguide 10. Factor (iii) is newly introduced herein: qualitatively, a short spin pitch on the multimode optical waveguide 10 provides stronger mode scrambling within the multimode optical waveguide 10 and causes greater propagation loss. On the opposite, a long spin pitch minimizes propagation loss within the multimode optical waveguide 10 but provides lower mode scrambling. Experimental tests showed that a pitch of 1 cm value that provides a good trade-off between mode scrambling and propagation loss. Furthermore, the multimode optical waveguide 10 shall be longer than one pitch length in order to provide significant mode scrambling.

The dimensions of the various elements forming the multimode optical waveguide 10 may vary and those used in the experimental set-up described below reflect a particular realization. Those of ordinary skill in the art will be able to adapt the dimensions of the optical waveguide to meet the specific needs of an intended application.

Experimental Results on Mode Scrambling Properties of the Multimode Waveguide with Off-Centered, Spun Hexagonal Core.

An experiment was performed to study a far-field intensity profile (also simply called ‘far-field’) in order to demonstrate the mode scrambling properties of the multimode optical waveguide 10. The far-field measurement provides a direct evidence of mode scrambling. In fact, applied to multimode optical waveguides, Fraunhofer theory explains that the far-field intensity associated with a single mode supported by a step-index multimode optical waveguide consists essentially of a ring having an average radius that is proportional to the order of the mode. In other words, the broader the far-field intensity profile, the higher is the scrambling effect of the multimode optical waveguide.

The far-field was measured for several illumination conditions of the multimode optical waveguide 10. The multimode optical waveguide was illuminated by an input waveguide connected to the multimode optical waveguide 10 with various amounts of lateral offset. SMF-28™ single-mode fiber was used as input waveguide in this experiment.

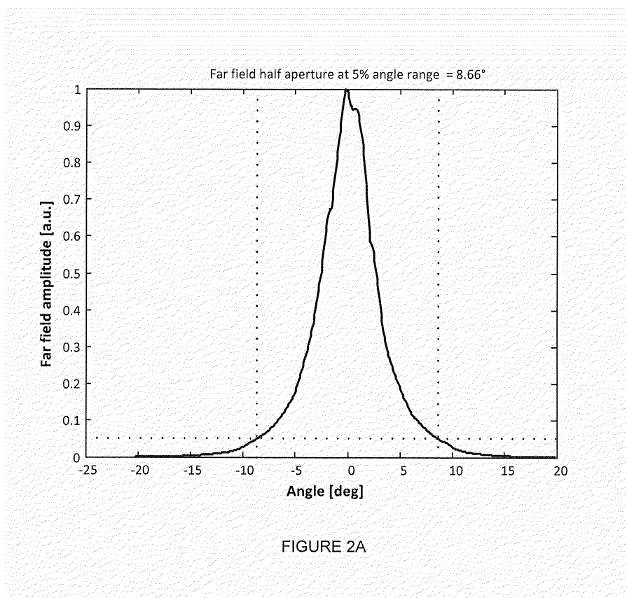

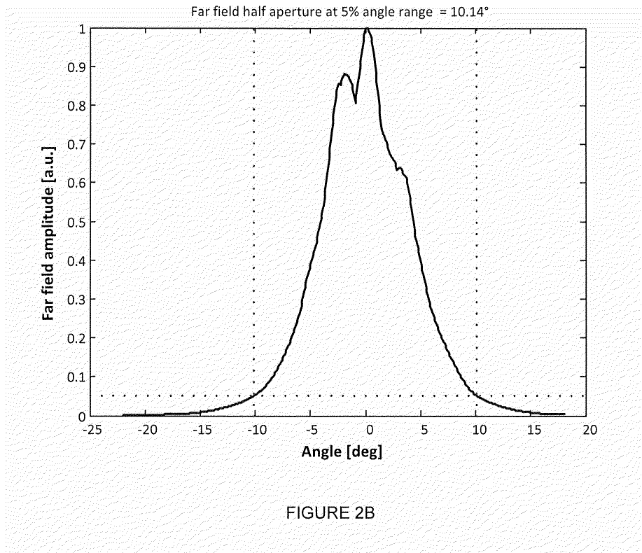

FIG. 2A shows the far-field intensity profile (angular distribution) when the input waveguide is spliced to a multimode optical waveguide 10 having a straight (non-coiled) hexagonal core. In turn, FIG. 2B shows the far-field intensity profile (angular distribution) for an input waveguide spliced to a multimode optical waveguide 10 having a spun hexagonal core. The multimode optical waveguide 10 with a spun hexagonal core shows a broader far-field compared to the waveguide with straight core. This is attributed to a more effective mode scrambling upon propagation along the spun core waveguide. It may be observed on FIG. 2B that a scrambling effect of the multimode optical waveguide 10 helps meeting a half-aperture of about 10° at 5% far-field intensity, compared to a half-aperture of 8.66° at 5% far-field intensity as shown on FIG. 2A. The scrambling properties have been measured for a multimode optical waveguide 10 having the following approximate dimensions: a core diameter of 47.7 μm, a core offset of 80 μm, a cladding diameter of 344 μm, and a spin pitch of 1 cm. These dimensions are not limiting the present disclosure and are provided for illustration purposes only.

### Mode Scrambler

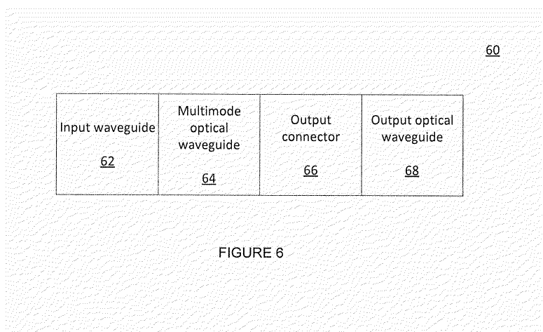

FIG. 6 is a schematic illustration of a mode scrambler according to an embodiment. A mode scrambler 60 comprises an input waveguide 62, which may be any suitable single-mode or multimode waveguide. The mode scrambler further comprises a multimode optical waveguide 64. The multimode optical waveguide 64 may be constructed as in the above description of FIG. 1 and thus comprises a cladding and a core having a polygonal cross-section, the core forming a coil spun around an axis of the cladding. The multimode optical waveguide 64 is connected to the input waveguide 62 and receives light therefrom, which is coupled to a set of guided modes of the multimode optical waveguide 64. In an embodiment, the multimode optical waveguide 64 is spliced to a single-mode input fiber with a lateral offset. The multimode optical waveguide 64 may have a length of a few centimeters (cm), thus exceeding the pitch of the coil, and thereby be adapted for providing a mode scrambling function. As a particular example, the coil may have a pitch of about one (1) cm and the multimode optical waveguide 64 may have a length of at least two (2) cm. The mode scrambler 60 may further comprise an output connector 66 connected to an output optical waveguide 68.

The multimode optical waveguide 64 is a MMF as previously described with respect to FIG. 1. In some variants, the output connector 66 and the output optical waveguide 68 may be formed of 50-μm GRIN (graded-index) MMFs.

In an aspect, the design of the mode scrambler 60 may be optimized according to one or more of the following factors: (i) a MPD measured at a specific point at the input of the multimode optical waveguide 64, (ii) a MPD measured after the multimode optical waveguide 64, (iii) a refractive-index profile and numerical aperture of the output optical waveguide, and (iv) an operating wavelength. The mode scrambler 60 can be designed to provide strong coupling among the modes guided by the multimode optical waveguide 64, thus redistributing the input power over a large number of guided modes. Hence, the mode scrambler improves the uniformity of the output MPD with respect to the input MPD. The output MPD can be adjusted through control of the mode scrambling function of the multimode optical waveguide 64 and through control of the lateral offset of the splicing between the input waveguide 62 and the multimode optical waveguide 64.

The MPD on the output optical waveguide 68 is further influenced by the light coupling occurring at the interfaces between the multimode optical waveguide 64, the output connector 66 and the output optical waveguide 68. Appropriate control of the mode scrambler parameters may allow meeting a target MPD on the output waveguide 68.

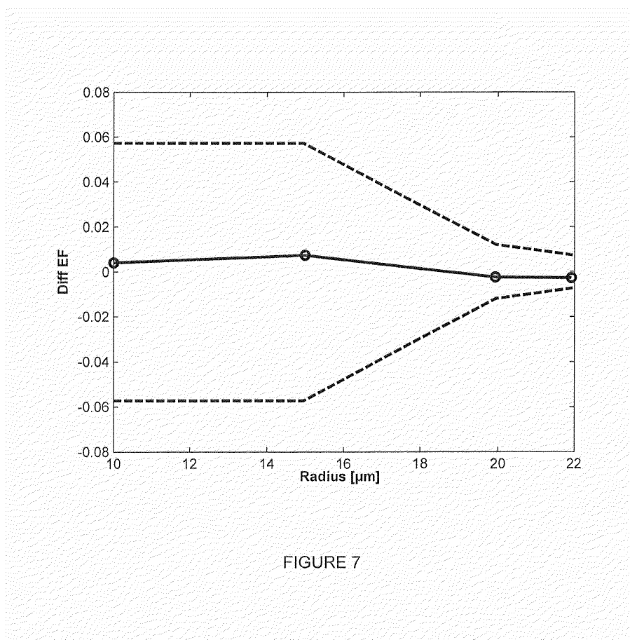

A particular embodiment of the mode scrambler 60 aims at obtaining a measured EF at the output waveguide 68 which complies with the IEC 61280-4-1 standard. This particular embodiment further aims at obtaining such result without the use of a mode filter, so as to decrease losses usually added by the presence of a mode filter. In this particular embodiment, the input waveguide is a SMF (type ITU-T G.652) and the output waveguide is a standard 50-μm MMF (type ITU.-T G.651) for telecom applications. FIG. 7 is a graph showing experimental results obtained with this particular embodiment. The graph shows in dashed lines the amplitude of the Encircled Flux acceptance mask defined by the IEC 61280-4-1 standard, that is the maximum acceptable deviation from the IEC 61280-4-1 Encircled flux target. In solid line, the graph shows the measured differential EF values, that is the difference between the IEC 61280-4-1 Encircled flux target and measured encircled flux at the output waveguide 68. The horizontal axis on the graph represents the radial position, in μm, within the core of the multimode optical waveguide 64. The encircled flux experimentally obtained for this particular embodiment is thus well within the IEC 61280-4-1 standard acceptance mask.

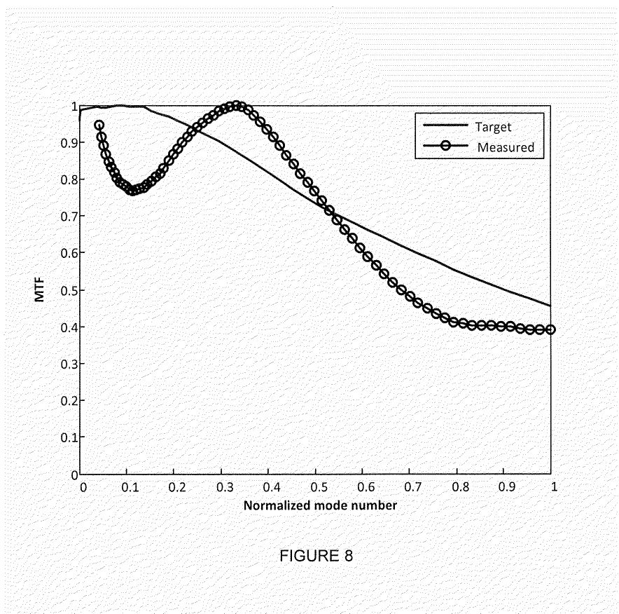

FIG. 8 is a graph comparing the measured MTF and target MTF as a function of normalized mode number, for the particular embodiment of the mode scrambler of FIG. 7. The MTF was measured at the output waveguide 68. The measured MTF is close to the target MTF for all normalized mode numbers. FIG. 8 demonstrates that the mode scrambler distributes the power for the input SMF onto a large number of guided modes of the output waveguide, and that the MTF on the output waveguide can be controlled in order to be similar to an expected target.

A particular realization of the mode scrambler 60 used for producing the results shown on FIGS. 7 and 8 takes a cylindrical shape with a length of 50 mm and a width of 5 mm. The performance and size of this particular embodiment of the mode scrambler 60 thus compare favorably with conventional devices, with similar insertion losses under comparable illumination conditions using a non-coherent source and an SMF input waveguide. It is understood that the losses may vary according to a degree of modal filtering that may be added to the mode scrambler 60 if a mode filter is added at its output.

### Mode Filter

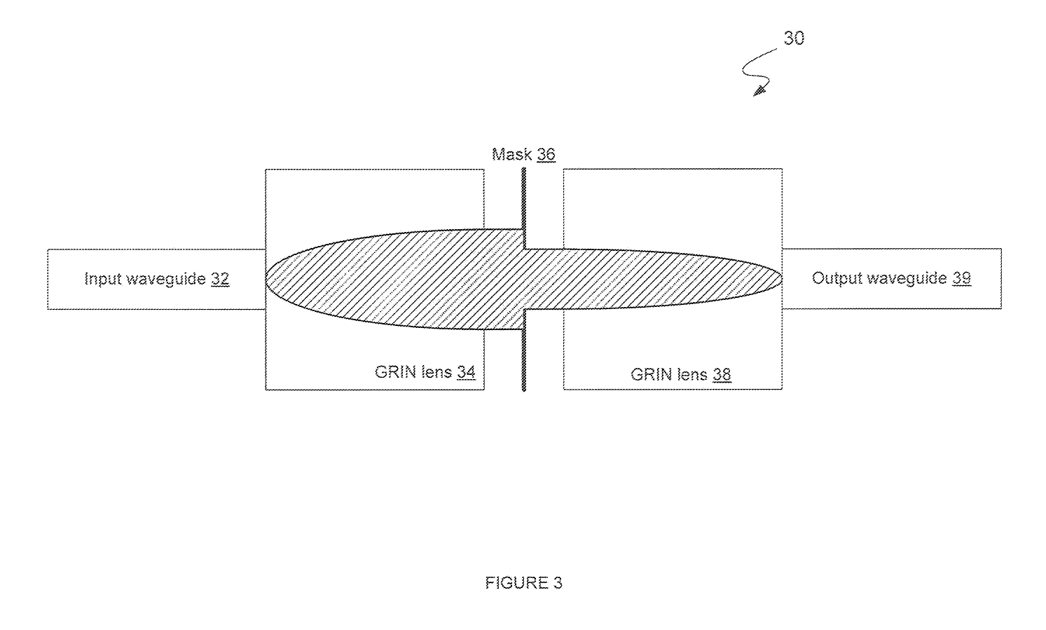

FIG. 3 is a schematic view of a mode filter. The mode filter 30 is capable of providing a controlled mode-dependent loss that is higher for the high-order guided modes of an input waveguide, with respect to the fundamental and lower-order guided modes. The mode filter 30 comprises an input optical waveguide 32, a first GRIN lens 34, a mask 36, a second GRIN lens 38 and an output waveguide 39.

The operation of the mode filter is explained by the Fraunhofer theory of diffraction. Applied to multimode optical waveguides, Fraunhofer theory explains that the far-field intensity associated with a mode guided by a step-index optical waveguide essentially consists of a ring having an average radius that is proportional to the order of the mode. Hence, at the output of the optical waveguide, a spread angle can be associated with each order of mode. The Fraunhofer diffraction theory links the spread angle and position in space in far-field in terms of a Fourier transform.

A far-field image may also be obtained at the focal plane of a lens appropriately positioned at the output of an optical waveguide. The focal plane is a Fourier plane equivalent to the far-field where each transverse spatial coordinate is associated with a spread angle relative to an axis of the optical waveguide.

An inverse relation may also be obtained: a two-lens system, well known as a ‘4-f system’ allows passing from near-field to far-field on a Fourier plane between the two lenses, returning to near-field at the focal plane beyond the second lens.

Consider a 4-f system positioned between an input multimode step-index waveguide and an output multimode waveguide with any index profile. This arrangement allows filtering high-order modes from the input step index waveguide using a circular mask (or a circular opening) that blocks intensities associated with high angles of propagation. The unfiltered modes are coupled back to the output multimode waveguide at the focal plane beyond the 4-f system.

A 4-f system using standard lenses is quite difficult to adjust. Moreover, such system is large in relation to the waveguides. It is therefore more appropriate to use GRIN lenses such as the GRIN lenses 34 and 38 of FIG. 3. GRIN lenses are more compact and are such that the Fourier plane coincides with an output face of the first GRIN lens 34, when an appropriate lens length is used.

Raytrace models of GRIN lenses show that an optical ray incident on the front surface of a GRIN lens follows a sinusoidal path while propagating along the lens axis. The “pitch” of the lens defines the lens length as the fraction of one full sinusoidal path period. In a monochromatic situation, the output plane of a GRIN lens having a pitch of 0.25 is a Fourier plane. In the particular case of incoherent illumination, the intensity pattern at the focal plane is such that, for each wavelength taken separately, a Fourier transform link applies, in which equation (2) applies:

I(λ,r)∝I⁻(λ,θ) (2)

The resulting overall pattern is thus a weighted sum of each wavelength-specific Fourier transform. Otherwise stated, except for unlikely adverse situations, mode filtering with a 4-f system is operative under both coherent and incoherent regimes.

### Mode Filter—Experimental Results

The mode filter 30 has been evaluated in an experimental setup. The setup was implemented using Newport™ F—COL-62-13 GRIN lenses having a pitch of 0.25 at 1300-nm wavelength. 62.5 μm/125 μm GRIN fiber patch cords were used as the input optical waveguide 32. The mask 36, which was an amplitude mask having an adjustable iris capable of closing almost completely, was placed between the two GRIN lenses 34 and 38. The two GRIN lenses 34 and 38 were aligned with a micro positioning system. The relative position of the GRIN lenses 34 and 38 was optimized for maximum transmission and for minimum modal filtering while the mask 36 was open. The diameter of the GRIN lenses 34 and 38 was approximately 1 mm. The minimum and maximum useful opening diameters of the iris of the mask 36 depended on the distribution of intensity on the input fiber and on the distance between the iris and the fiber. In the experimental case of our measurements, the opening diameter of the iris was in the range of about 0.2 mm to 2 mm.

The input optical waveguide 32 was illuminated with a light emitting diode (LED) source at 1300 nm to meet an overfill condition of the input optical waveguide 32. Care was taken to properly align the GRIN lenses 34 and 38 in order ensure an overfill condition of the output optical waveguide 39 when the iris was fully open. Closing of the iris allowed transiting between an overfill condition, an IEC 61280-4-1 compliant encircled flux (EF) condition, and an underfill condition.

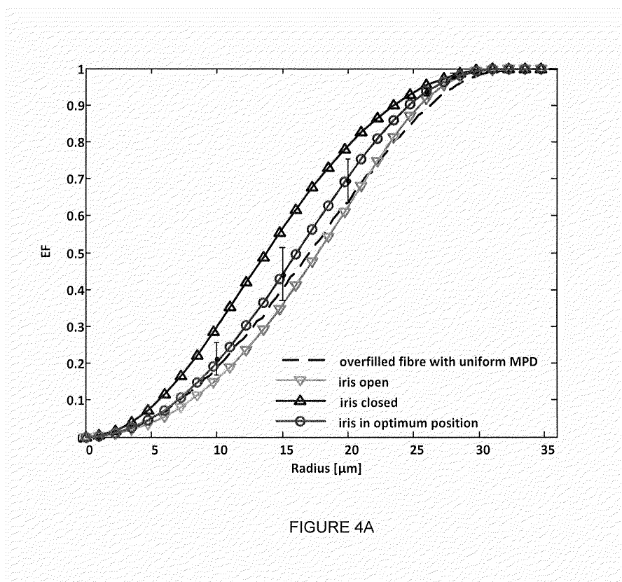

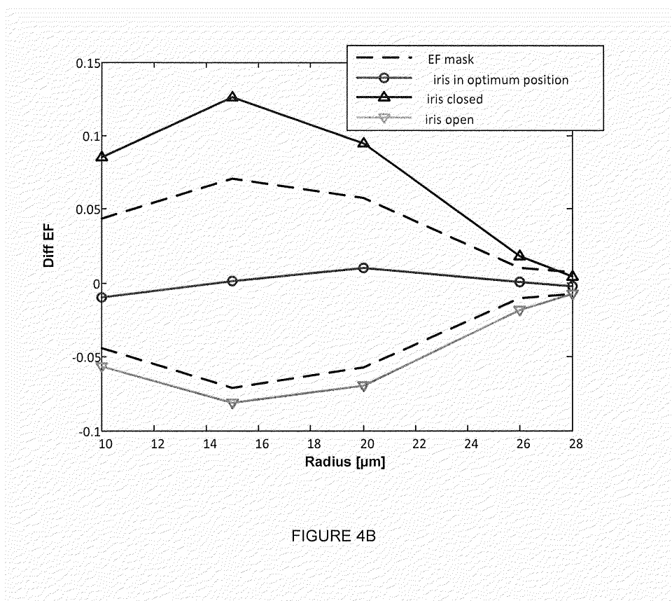

FIGS. 4A and 4B are graphs showing the experimentally measured encircled flux (FIG. 4A) and differential encircled flux (FIG. 4B) for various iris opening settings of the mode filter of FIG. 3. FIG. 4A shows the correspondence between the measured encircled flux (EF) values (dimensionless) on the vertical axis and the opening radius (in μm) of the iris on the horizontal axis. The EF curves are shown for three (3) iris opening conditions, including a first curve for an open iris, a second curve for a closed iris, and a third curve for an iris in optimum, partly closed position. The dashed curve shows the EF for a theoretical overfilled fiber with uniform MPD. The markers reflect the compliance mask defined by the IEC 61280-4-1 standard. As small differences in the EF curves are hard to see in FIG. 4A, the same result is reproduced in FIG. 4B in terms of differential EF, which is the difference between the measured EF curves and the IEC 61280-4-1 encircled flux target. In FIG. 4B, the Differential EF (dimensionless) is shown on the vertical axis and the iris opening radius (in μm) is shown on the horizontal axis. Differential EF curves are shown for three (3) iris opening conditions, including a first curve for an open iris, a second curve for a closed iris, and a third curve for an iris in optimum, partly closed position. The curves in dashed lines show the Encircled Flux acceptance mask defined by the IEC 61280-4-1 standard, i.e. the maximum acceptable deviation from the IEC 61280-4-1 Encircled flux target. An underfill condition is generally present in positive Differential EF conditions while an overfill condition is generally present in negative Differential EF conditions. FIGS. 4A and 4B demonstrate that, in the experimental conditions discussed above, it was possible to control the EF curve measured at the output waveguide 39 by controlling the aperture of the iris. Closing the iris filtered high-order modes and allowed passing from an overfilled condition, represented by the curve below the lower IEC 61280-4-1 mask limit, to an underfilled condition represented by the curve above the upper IEC 61280-4-1 mask limit. Furthermore, for an intermediate aperture of the iris, an EF curve compliant to the IEC 61280-4-1 mask was obtained.

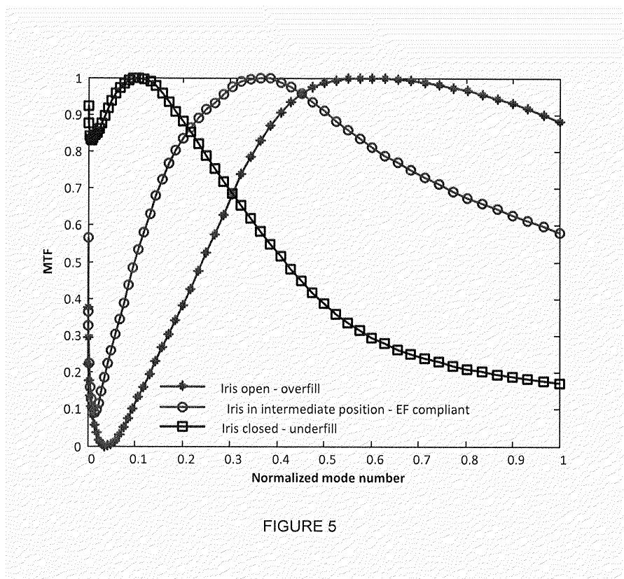

As a further demonstration of the mode filtering properties of the mode filter 30, FIG. 5 shows the mode transfer functions for various iris opening conditions. The vertical axis represents the mode transfer function (MTF) and the horizontal axis represents the normalized mode number. In MTF graphs like the one in FIG. 5, high-order modes are modes with high normalized mode number. A high MTF value at a given normalized mode number means that the mode represented by that mode number carries a proportionally high portion of the total power propagating over the waveguide. In FIG. 5, curves are shown for the same three (3) iris opening conditions of FIGS. 4A and 4B, including a first curve for an open iris, a second curve for a closed iris, and a third curve for an iris in optimum, partly closed position. It may be seen from FIG. 5 that it is possible to move from an overfilled condition with strong content of high-order modes (iris open, high MTF values for modes with high normalized mode number) to an underfilled condition where these high-order modes are filtered (iris closed, low MTF values for modes with high normalized mode number).

### Mode Conditioner

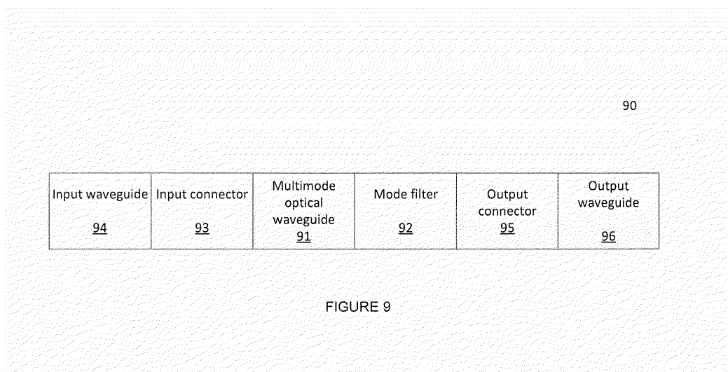

FIG. 9 is a schematic illustration of a mode conditioner according to another embodiment. The mode conditioner 90 comprises a multimode optical waveguide 91. The multimode optical waveguide 91 may be constructed as in the above description of FIG. 1 and thus comprises a cladding and a core having a polygonal cross-section, the core forming a coil spun around an axis of the cladding. The multimode optical waveguide 91 is a MMF and thus guides many modes with order ranging from the fundamental mode to some higher-order mode. The multimode optical waveguide 91 may be lit with an optical signal coupling to some or all of these modes, with a generally unknown, uncontrolled, underfilled or otherwise unwanted MPD. The optical signal may comprise coherent or non-coherent illumination. The mode conditioner 90 also comprises a mode filter 92 configured to filter high-order modes. The mode filter 92 is connected to the output of the multimode optical waveguide 91 and may have a length of a few centimeters. The multimode optical waveguide 91 may also have a length of a few centimeters, exceeding the pitch of the coil, thereby being capable of forming, in combination with the mode filter 92, a mode conditioner. As a particular example, the coil may have a pitch of about 1 cm and the multimode optical fiber 91 may have a length of at least 2 cm.

The mode conditioner 90 may also comprise an input connector 93 for lighting the multimode optical waveguide 91 with the optical signal. The input connector 93 may comprise a SMF that may be spliced to the multimode optical waveguide 91 with a lateral offset. Alternatively, the input connector 93 may comprise a MMF having a length of a few millimeters. An input waveguide 94 may connect to the input connector 93, and may comprise a SMF, a 50-μm GRIN MMF, or any other suitable optical waveguide.

The mode conditioner 90 may further comprise an output connector 95 connected to the mode filter 92 and may further comprise an output waveguide 96 connected to the output connector 95. For example, the output connector 95 and the output waveguide 96 may be formed of 50-μm graded-index MMFs, or of any other suitable optical waveguide.

The mode filter 92 may be constructed for example of two GRIN lenses with a mask being inserted between them, as in the case of the mode filter 30 described hereinabove. Other constructions of the mode filter 92, for example including a mask with an adjustable radius, are also within the scope of the present disclosure.

Those of ordinary skill in the art will realize that the descriptions of the present multimode optical waveguide, mode scrambler and mode conditioner are illustrative only and are not intended to be in any way limiting. Other embodiments will readily suggest themselves to such persons with ordinary skill in the art having the benefit of the present disclosure. Furthermore, the disclosed multimode optical waveguide, mode scrambler and mode conditioner may be customized to offer valuable solutions to existing needs and problems of controlling the mode power distribution of the light guided in optical waveguide systems.

For the sake of clarity, not all of the features of the implementations of the multimode optical waveguide, mode scrambler and mode conditioner have been shown and described. It will, of course, be appreciated that during the course of development of any implementation of the multimode optical waveguide, mode scrambler and mode conditioner, numerous implementation-specific decisions may need to be made in order to achieve the developer's specific goals, such as compliance with application-, system-, network- and business-related constraints, and that these specific decisions will vary from one implementation to the other and from one developer to the other. Moreover, it will be appreciated that the development effort can be complex and time-consuming, but would nevertheless be a routine undertaking of engineering for those of ordinary skill in the field of optical waveguide systems having the benefit of the present disclosure.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A multimode optical waveguide, comprising:
a cladding; and
an off-centered core having a polygonal cross-section, the core forming a coil spun around an axis of the cladding.

2. The multimode optical waveguide of claim 1, wherein the core has a cross-section selected from a triangular cross-section, a rectangular cross section, a pentagonal cross-section, a hexagonal cross-section, a heptagonal cross-section and an octagonal cross-section.

3. The multimode optical waveguide of claim 1, wherein the cross-section of the core forms a regular polygon.

4. The multimode optical waveguide of claim 1, wherein the multimode optical waveguide is a step-index fiber.

5. The multimode optical waveguide of claim 1, wherein the coil has a pitch of about 1 cm.

6. The multimode optical waveguide of claim 1, wherein the cladding and the core are made of polymer materials.

7. The multimode optical waveguide of claim 1, wherein:
the cladding is made of fluorinated SiO₂; and
the core is made of SiO₂.

8. The multimode optical waveguide of claim 1, wherein:
the cladding is made of SiO₂; and
the core is made of doped SiO₂.

9. Use of the multimode optical waveguide of claim 1 as a mode scrambler.

10. A mode scrambler, comprising:
an input waveguide; and
a multimode optical waveguide connected to the input waveguide, the multimode optical waveguide comprising:
a cladding; and
a core having a polygonal cross-section, the core forming a coil spun around an axis of the cladding.

11. The mode scrambler of claim 10, wherein:
the input waveguide comprises a single-mode waveguide; and
the multimode optical waveguide is spliced to the single-mode waveguide with a lateral offset.

12. The mode scrambler of claim 11, comprising:
an output connector connected to the optical waveguide; and
an output waveguide connected to the output connector.

13. The mode scrambler of claim 12, wherein the output waveguide comprises a graded-index multimode waveguide.

14. The mode scrambler of claim 12, wherein the multimode optical waveguide has a length exceeding a pitch of the coil.

15. The mode scrambler of claim 14, wherein:
the coil has a pitch of about 1 cm; and
the multimode optical waveguide has a length of at least 2 cm.

16. Use of the mode scrambler of claim 11 to minimize speckle in a laser projector.

17. A mode conditioner, comprising:
a multimode optical waveguide comprising:
a cladding; and
a core having a polygonal cross-section, the core forming a coil spun around an axis of the cladding; and
a mode filter configured to filter higher-order guided modes of the multimode optical waveguide, the mode filter being connected to an output of the multimode optical waveguide.

18. The mode conditioner of claim 17, further comprising an input connector for lighting the multimode optical waveguide with an optical signal.

19. The mode conditioner of claim 18, wherein:
the input connector comprises a single-mode waveguide; and
the multimode optical waveguide is spliced to the single-mode waveguide with a lateral offset.

20. The mode conditioner of claim 17, further comprising an output connector connected to the mode filter.

21. The mode conditioner of claim 20, further comprising an output waveguide connected to the output connector.

22. The mode conditioner of claim 21, wherein the output waveguide comprises a graded-index multimode fiber.

23. The mode conditioner of claim 17, wherein the multimode optical waveguide has a length exceeding a pitch of the coil.

24. The mode conditioner of claim 23, wherein:
the coil has a pitch of about 1 cm; and
the multimode optical waveguide has a length of at least 2 cm.

25. The mode conditioner of claim 17, wherein the mode filter comprises:
two graded-index lenses; and
a mask located between the two graded-index lenses.
